(19) United States
(12) Patent Application Publication
(10) Pub. No.: US 2014/0274371 A1
(43) Pub. Date: Sep. 18, 2014

(54) TRIGGERING OF MULTI-PLAYER MINI GAMES

(71) Applicant: BIG FISH GAMES, INC., Seattle, WA (US)

(72) Inventors: Seppo Takashi Helava, Oakland, CA (US); Andrew James Vella, Oakland, CA (US); Crystal Elizabeth Silva, Oakland, CA (US); Carey Jean DiJulio, Seattle, WA (US)

(73) Assignee: BIG FISH GAMES, INC., Seattle, WA (US)

(21) Appl. No.: 13/802,060

(22) Filed: Mar. 13, 2013

(51) Int. Cl. A63F 13/40

(52) U.S. Cl. CPC A63F 13/10
USPC 463/31

(57) ABSTRACT

The systems and/or processes described herein enable multiple users to play a single player game, such as playing a game within a virtual environment. In response to one or more criteria associated with the single player game being satisfied, a multi-player mini game may be presented to the multiple users. The multi-player mini game may cause the multiple users to collaborate with one another to achieve a common goal or to compete against one another for the purpose of obtaining an award. During play of the multi-player mini game, a progression or performance of each of the multiple users may be displayed in real-time. In response to determining a winner of the multi-player mini game, an award may be provided to the winner. Then, the multiple users may resume play of the single player game.

### BACKGROUND

With the growing popularity of casual gaming, consumers are able to play various types of games utilizing different mediums, including computing devices, tablet devices, mobile telephones, etc. Individuals may play a particular game independently or with other individuals that are also interested in playing that game. For instance, the individuals may play the game against other individuals or in collaboration with those individuals. Via a network, individuals may play a game in association with a virtual environment, where each of the participating individuals may be represented within the virtual environment. However, in single player games where individuals independently play the game (e.g., not in competition or in collaboration with others), the individuals may not have the opportunity to play with or against other individuals while the single player game is being played.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including one or more users, one or more user devices, one or more networks, and one or more content servers. In this system, during play of a particular game, a multi-player mini game may be presented to the users.

FIG. 2 is a flow diagram showing an example process of providing a multi-player mini game to multiple users.

FIG. 3 is a diagram showing an example user interface that provides a game to multiple users in a virtual environment.

FIG. 4 is a diagram showing an example user interface that presents a multi-player mini game to multiple users in response to certain criteria being satisfied.

### DETAILED DESCRIPTION

This disclosure describes systems and processes for triggering multi-player mini games within a particular game (e.g., the main or primary game), such as a game being played in a virtual environment, where some or all of the players of the game may participate in the multi-player mini games. More particularly, the multi-player mini games may be initiated in response to determining that a certain criteria associated with the game has been satisfied or in response to determining that a particular event associated with the game has occurred. In response to a multi-player mini game being triggered, each player of the game may participate in the multi-player mini game and compete against, or collaborate with, the other players. Upon completion of the multi-player mini game, which may possibly be due to one or more of the players winning the multi-player mini game, the individuals may resume the game that was initially being played. For the purposes of this discussion, the games described above and set forth in additional detail below may include physical games and games that are played online, such as games played via a network (e.g., the Internet) and games that are downloaded to, or are accessible by, a user device.

In some embodiments, multiple individuals may play a game (e.g., a card game, a slot machine game, etc.) within a virtual environment that may be displayed on respective user devices (e.g., laptop computers, mobile devices, tablet computers, etc.). Within the virtual environment, each of the participating individuals may be represented therein (e.g., via text, an image, an avatar, etc.). Each of the individuals may play the game individually and independently, as opposed to playing against, or in collaboration with, the other individuals that are also playing the game within the virtual environment. In various embodiments, each of the individuals may be progressing towards a certain goal or reward (e.g., a currency, a score, completion of a level, a prize, etc.). During game play, a predetermined event (e.g., criteria) may occur that causes the game to transition into a multi-player mini game that is to be played by each of the individuals. For instance, one of the players may reach a certain score, receive a particular card, or hit a particular set of reels via a virtual or physical slot machine.

The multi-player mini game may represent a competitive and/or collaborative game, which may be similar or different from the main (e.g., single player) game. In the mini game, two or more of the individuals playing the main game may participate in the mini game. Moreover, the multi-player mini game may identify a goal (e.g., a score, a currency, etc.) that the players attempt to reach. For example, provided that the players are playing a virtual slot machine within the environment, the multi-player mini game may encourage the players to actuate the reels in order to achieve a certain goal (e.g., a predetermined number of chips or tokens). During the multi-player mini game, the system may display the progression, performance, or status of each of the participating players. When one or more of the players reaches the goal, the one or more players may be declared the winner(s) of the multi-player mini game and may receive an award or prize. Thereafter, the multi-player mini game may conclude and the game that the individuals were previously playing may resume.

As a result, the systems and processes set forth herein describe the transition from a single player game to a multi-player collaborative and/or competitive game, where the multi-player mini game shows the real-time progression of each of the participating players while the multi-player mini game is being played. The multi-player mini game may be triggered in response to one or more criteria associated with the game being satisfied by at least one of the individuals that is playing the main game within the virtual environment.

The discussion begins with a section, entitled “Example Environment,” describing a system for triggering a multi-player mini game. Next, the discussion includes a section, entitled “Example processes,” that illustrates and describes example processes for transitioning between a single player game and a multi-player collaborative and/or competitive mini game. A “Single Player Game” section then follows, which describes that multiple players may independently play a single player game within a virtual environment. The discussion then moves on to a “Triggering a Multi-Player Mini Game” section that describes transitioning multiple users from a single player game to a collaborative and/or competitive multi-player mini game. Lastly, the discussion includes a brief “Conclusion.”

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

FIG. 1 illustrates an architecture 100 in which a user 102 may electronically or physically access games 116 (e.g., software games, casual games, physical games, games played for real or virtual currency, games of chance, etc.) and play those games 116, such as via a user device 104. As described below, the user device 104 may be implemented in any number of ways, such as a computer, a laptop computer, a tablet device, a personal digital assistant (PDA), a multi-functioning communication device, and so on. The user 102 may access the games 116 over a network 106, such as the Internet, which may be communicatively coupled to one or more content server(s) 108. The content server(s) 108 may store various types of games 116, such as software games, and other content that is accessible by the user device 104 (e.g., media content, audio content, video content, etc.). For instance, the user 102 may access and/or play the games 116 via one or more sites (e.g., a website) that are accessible via the network(s) 106 and/or via an application associated with the user device 104. One or more processor(s) 110, a memory 112, and a display 114 of the user device 104 may enable the user 102 to access and/or play the games 116. In addition to the games 116 being stored on, and/or accessed via, the content server(s) 108, the games 116 may also be stored directly on the user device 104.

Furthermore, one or more processor(s) 118 and a memory 120 of the content server(s) 108 may allow the content server(s) 108 to enable the users 102 to play the games 116 and to also present one or more multi-player mini games that are triggered during play of the games 116. More particularly, a game play module 122, a criteria determination module 124, a multi-player mini game module 126, and a multi-player mini game status module 128 are stored in memory 120 and executed by the processor(s) 118 to enable the content server(s) 108 transition the users 102 from playing a single player game 116 to playing a multi-player collaborative and/or competitive mini-game in response to predetermined criteria associated with the single player game 116 being satisfied.

For the purposes of this discussion, the games 116 may include physical games and games that may be played online or via a user device 104. Moreover, the games 116 may be played for real currency (e.g., U.S. dollars) or virtual currency (e.g., chips, tokens, etc.). The games 116 may also relate to games of chance or casual gaming, which may include physical games, online games that may be played over the network(s) 106, and/or software games that may be stored on, and/or be accessible by, the user device 104.

Games of chance may refer to games in which the outcome is at least partly random or is influenced at least in part by a randomizing device. In games of chance, the players may elect to wager real or virtual currency, or anything of monetary value, prior to at least a portion of the game being played (e.g., spinning a set of reels). Examples of games of chance may include physical games, games played via a network 106, or games played via a user device 104, such as dice games, spinning tops, playing cards, slot machines, roulette wheels, and many other casino games. A game of chance may have some skill element, although the chance or randomness of the game may play a greater role in determining the outcome of the game. In other games of chance, a certain degree of skill may enhance a player's performance with respect to the game. This may be the case where the player(s) make game decisions based upon previous or incomplete knowledge, such as in various casino or card games (e.g., blackjack, poker, etc.).

On the other hand, casual games may include games (e.g., video games) that are associated with any type of gameplay and any type of genre. Casual games may have a set of simple rules that allow a large audience to play, such games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices, etc., and may be played online via a web browser. Casual games may be referred to as “casual” since the games may be directed towards consumers who can come across the game and get into gameplay in a short amount of time, if not immediately. Examples of casual games may include puzzle games, hidden object games, adventure games, strategy games, arcade and action games, word and trivia games, casino games, and/or card and board games.

Other games 116 may first be downloaded to and/or installed on the user device 104 and/or an application associated with the user device 104. These games 116, and the physical games, the games of chance, and the casual games 116 described above, may also be acquired by the user 102. Regardless of whether the games 116 are stored on the user device 104 or the content server(s) 108, playing the games 116 may include accessing, viewing, trying, and/or otherwise interacting with the games 116.

The users 102 may access the games 116 in any of a number of different manners. For instance, the users 102 may play the games 116 in a physical setting (e.g., physical slot machines). The users 102 may also access a site (e.g., a website) associated with an entity, such as a merchant, that provides access to the games 116. Such a site may be remote from the user device 104 but may allow the users 102 to interact with the games 116 via the network(s) 106. Moreover, the users 102 may download one or more applications to the user device 104 in order to access the games 116. In this case, the content server(s) 108 may provide, transmit, suggest, and/or recommend the games 116 to the user device 104, whereby the users 102 may interact with the games 116 via the downloaded application(s). In other embodiments, the games 116 may be streamed from the content server(s) 108 to the user device 104 such that the users 102 may interact with the games 116 in real-time. Once the user 102 accesses the games 116, the users 102 may perform a variety of actions, including learning about the games 116, viewing the games 116, trying the games 116, acquiring (e.g., purchasing, renting, leasing, etc.) the games 116, downloading/installing the games 116 to the user device 104, and/or playing the games 116.

Additionally, the users 102 may have a user account associated with the entity that provides and/or provides access to the games 116. For instance, assuming that the games 116 are available via a website, each of the users 102 may have a user account that specifies various types of information relating to the users 102. This information may include personal information, user preferences, and/or some user identifier (ID), which may be some combination of characters (e.g., name, number, etc.) that uniquely identifies the user 102 from other users 102.

In some embodiments, the user device 104 may be any type of device that is capable of receiving, accessing, playing, and/or otherwise interacting with the games 116, such as, for example, a personal computer, a laptop computer, a cellular telephone, a personal digital assistant (PDA), a tablet device, an electronic book (e-Book) reader device, a television, or any other device that may be used to access games 116 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the games 116. Further, the user device 104 shown in FIG. 1 is only one example of a user device 104 and is not intended to suggest any limitation as to the scope of use or functionality of any user device 104 utilized to perform the processes and/or procedures described herein. Although the games 116 may be played via the user device 104, certain games 116 may be played without the use of a user device 104. For example, various physical games and/or games of chance (e.g., slot machines, table top games, etc.) may be played in a physical setting without use of such user devices 104.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites associated with games 116 and/or download applications that are used to access and/or play the games 116. Additionally, each of the processor(s) 110 may possess its own local memory, which also may store program modules, program data, and/or one or more operating systems.

In at least one configuration, the memory 112 of the user device 104 may include any component that may be used to access, play, and/or download the games 116. Depending on the exact configuration and type of the user device 104, the memory 112 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the content server 108 via the network(s) 106. More particularly, the display 114 of the user device 104 may include any type of display known in the art that is configured to present (e.g., display) information to the user 102. For instance, the display 114 may be a screen or user interface that allows the user 102 to access, play, and/or download the games 116. Further, one or more local program modules may be utilized to play the games 116 on a browser. The local program modules may be stored in the memory 112 and/or executed on the processor(s) 110 in order to present graphics associated with the games 116 on the display 114.

In some embodiments, the network(s) 106 may be any type of network known in the art, such as the Internet. Moreover, the user device 104 and the content server(s) 108 may communicatively couple to the network(s) 106 in any manner, such as by a wired or wireless connection. The network(s) 106 may also facilitate communication between the user device 104 and the content server(s) 108, and also may allow for the transfer of data or communications therebetween. For instance, the content server(s) 108 and/or other entities may provide access to the games 116 that may be accessed, played, and/or downloaded utilizing the user device 104.

In addition, and as mentioned previously, the content server(s) 108 may include one or more processor(s) 118 and a memory 120, which may include the game play module 122, the criteria determination module 124, the multi-player game module 126, and the multi-player mini game status module 128. The content server(s) 108 may also include additional components not listed above that perform any function associated with the content server(s) 108. In various embodiments, the content server(s) 108 may be any type of server, such as a network-accessible server, or the content server(s) 108 may be any entity that provides access to the games 116 that is stored on and/or is accessible by the content server(s) 108.

In various embodiments, the game play module 122 may enable multiple users 102 to play one or more of the games 116. In particular, the game play module 122 may allow multiple users 102 to play one of the games 116 in a virtual environment. In some embodiments, multiple users 102 may independently play a single player game 116 in the virtual environment, where each of the users 102 is represented within the virtual environment by text, an image, an avatar, and/or other identifying information. During play of the game 116, each of the participating users 102 may progress towards a certain goal, such as an amount of points, an amount of currency (e.g., awards, trophies, dollars, chips, prizes, etc.), and/or reaching or passing levels associated with the game 116.

Moreover, the criteria determination module 124 may determine and/or maintain certain predetermined criteria associated with the game 116 that may be satisfied. The criteria may correspond to events associated with the game 116 that may occur or that may be caused by actions of at least one of the multiple users 102 that is currently playing the game 116. For instance, the predetermined criteria may correspond to one of the users 102 achieving a certain score, gaining a particular amount of currency (e.g., points, dollars, trophies, chips, awards, etc.), receiving one or more particular cards, and/or hitting a particular set of reels in a virtual slot machine context. The criteria determination module 124 may monitor the status of each user 102 that is playing the game 116, as well as the progress of each user 102 with respect to the game 116. As a result, the criteria determination module 124 may determine when one of the criteria has been satisfied, meaning that the criteria determination module 124 may determine when one of the events that is associated with the game 116 has occurred.

In response to determining that one or more of the predetermined criteria has been satisfied, the multi-player mini game module 126 may trigger the presentation of a multi-player mini game. The multi-player mini game module 126 may cause some or all of the users 102 that are playing the game 116 to participate in the multi-player mini game. The multi-player mini game may be collaborative or competitive in nature, such that the participating users 102 may play together for the purpose of achieving a shared goal, or the participating users 102 may compete (e.g., play against) one another. Furthermore, when triggered, the multi-player mini game may be presented to each of the users 102 within the virtual environment and the progression, performance, or status of each of the users 102 that is playing the multi-player mini game may also be displayed in real-time. The multi-player mini game may correspond to any type of game that allows the users 102 to participate in a collaborative or competitive manner, such as a race, for instance. Moreover, the winner of the multi-player mini game may receive some benefit, such as an amount of points or currency, an award, an enhanced feature of the game 116 (e.g., unlocking of features of the game 116), and so forth.

The multi-player mini game status module 128 may determine the status of the multi-player mini game after the transition from the game 116 to the multi-player mini game. That is, the multi-player mini game status module 128 may monitor the progression of each user 102 that is participating in the multi-player mini game and also determine when one of the users 102 has won the multi-player mini game (e.g., by winning a race, earning a certain amount of points/currency, etc.). In other embodiments, the multi-player min game status module 128 may determine when a predetermined amount of time allotted for the multi-player mini game has expired.

In response, the multi-player mini game status module 128 may conclude the multi-player mini game and allow the users 102 to resume playing the game 116. As a result, the content server(s) 108 may allow the transition between a single player game 116 being played by multiple users 102 in a virtual environment to a multi-player collaborative and/or competitive mini game, in which the multi-player mini game is triggered in response to one or more criteria associated with the game 116 being met. Accordingly, users 102 that are independently playing a single player game 116 may have the opportunity to collaborate and/or compete with other users 102 playing the same game 116, as well as possibly earning value (e.g., points, currency, awards, etc.) as a result of participating in the multi-player mini game.

### Example Processes

FIG. 2 describes various example processes of transitioning multiple users playing a single player game to a multi-player collaborative and/or competitive mini game. The example processes are described in the context of the environment of FIG. 1 but are not limited to those environments. The order in which the operations are described in each example method is not intended to be construed as a limitation, and any number of the described blocks can be combined in any order and/or in parallel to implement each method. Moreover, the blocks in FIG. 2 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 2 is a flow diagram illustrating an example process 200 of transitioning multiple users playing a single player game to a multi-player collaborative and/or competitive mini game. Moreover, the following actions described with respect to FIG. 2 may be performed by a server, a service provider, a merchant, and/or the content server(s) 108, as shown in FIG. 1

Block 202 illustrates determining that multiple users are independently playing a game. In some embodiments, the content server 108 may determine that multiple users 102 are independently playing a single player game 116 that is associated with a virtual environment. For instance, multiple users 102 may be playing a single player slot machine game 116, where each of the users 102 is situated around a virtual table within the virtual environment with other users 102. For the purposes of this discussion, a single player game 116 may refer to a game 116 that may be played independently of other users 102, meaning that the performance or progression of a first user 102 with respect to the game 116 may not have an affect or influence on another user's 102 play of the game 116. The virtual environment may present information about each of the users 102 that is viewable by the other users 102 that are currently participating in (e.g., playing) the game 116. In some embodiments, such information may include text, graphics, images, avatars, etc., that identify the users 102. In addition, the information may include a current status or performance of each user 102 with respect to the game 116, such as a current score, an amount of currency earned, cards received, reels hit, jackpots won, etc. As a result, each of the users 102 that is playing the game 116 within the virtual environment may determine which other users 102 are also independently playing the game 116, and may be aware of the current status or performance of those users 102.

In some embodiments, although the multiple users 102 may each be independently playing a single player game 116, the game 116 may still have a social component. For instance, the users 102 playing within the virtual environment may communicate with the other users 102, such as by exchanging messages in the form of an online chat. The name, image, avatar, etc., associated with the users 102 may allow the users 102 to determine players that they know, have previously played with, etc. Moreover, since the users 102 that are playing the game 116 may be placed within a virtual environment with other users 102 who are also online, each user 102 may view the performance, progression, and current status of other users 102 with respect to the game 116. For example, if the users 102 are playing a virtual slot machine game 116, and one of the users 102 wins a jackpot by hitting a particular set of reels, the virtual environment may depict that that user 102 has in fact won the jackpot.

Block 204 illustrates determining that a criteria associated with the game has been satisfied by one of the multiple users. In some embodiments, the content server(s) 108 may identify certain criteria that may occur or be satisfied while the users 102 are playing the game 116. Such criteria may relate to one of the users 102 achieving a certain score, obtaining a particular amount of points or currency, receiving a specific card or set of cards, hitting a particular set of reels, passing a level of the game 1116, and so on. Therefore, the criteria may correspond to events associated with the game 116 that may occur during game play, in which the events may occur in response to one of the multiple users 102 performing a particular action (e.g., pressing a button, playing a card, beating an opponent, reaching a goal, spinning reels, etc.) with respect to the game 116. By monitoring each of the multiple users 102 as they are playing the game 116, the content server(s) 108 may determine when one of the criteria has been satisfied.

Block 206 illustrates presenting a multi-player mini game to be played by the multiple users. More particularly, in response to determining that at least one criteria associated with the game 116 has been satisfied (e.g., a particular event associated with the game 116 has occurred), the content server(s) 108 may cause a multi-player mini game to be presented to the users 102 within the virtual environment. The multi-player mini game may be presented to the users 102 in any manner, such as via a pop-up window, within the virtual environment, via a different virtual environment (e.g., a separate screen or page), adjacent to the game 116, via a window overlaid on the game 116, and so forth. The triggering of the multi-player mini game may cause the game 116 to pause, and then some or all of the multiple users 102 may participate in (e.g. play) the multi-player mini game. For instance, each of the users 102 playing the main game 116 may automatically be included in the multi-player mini game. Alternatively, those users 102 that previously expressed an interest in participating in the multi-player mini games may instead be included. In certain embodiments, the specific user 102 that triggered the multi-player mini game may also be displayed or otherwise revealed to the other users 102.

The multi-player mini game may refer to a collaborative and/or competitive game that may involve some or all of the users 102 that were playing the game 116 within the virtual environment. For instance, while the users 102 are playing the multi-player mini game, the participating users 102 may collaborate in an attempt to achieve a shared goal or the participating users 102 may compete against one another. Moreover, the multi-player mini game may relate to any theme and may refer to any game that illustrates the real-time progression or performance of the participating users 102 during the multi-player mini game. For instance, the progression of the users 102 may be shown as the users 102 racing around a track, filling up some object (e.g., a balloon, a bucket, etc.), a progress bar, weights on a scale, and so forth. In some embodiments, each of the participating users 102 may be represented by a symbol, an image, text, a color, etc., that uniquely identifies each user 102 and shows the progression or performance of each player with respect to the multi-player mini game. As a result, each user 102 may determine their performance in relation to the performance of other users 102 that are participating in the multi-user mini game.

Block 208 illustrates determining and displaying the progression of the multi-player mini game to the multiple users. As stated above, the progression or performance of each of the participating users 102 with respect to the multi-player mini game may be shown within the virtual environment. The progression may be represented by the placement of the users 102 around a track, an amount of points or currency (e.g., coins, dollars, chips, tokens, etc.) gained, or any other manner that illustrates how the users 102 are performing with respect to one another. As a result, the users 102 may adjust how they play the multi-player mini game based on the relative performance of the users 102. For instance, for a slot machine game 116, the users 102 may bet additional currency/points and/or spin the reels more rapidly if that will cause them to increase their chances of winning a jackpot and, therefore, cause the users 102 to have a better chance of winning the multi-player mini game.

Block 210 illustrates determining a winner of the multi-player mini game. In some embodiments, a winner (or multiple winners) of the multi-player mini game may be determined if at least one user 102 achieves a certain goal (e.g., crossing the finish line, accumulating a certain amount of points/currency, etc.). In other embodiments, one or more winners may be determined after a predetermined amount of time after the multi-player mini game has begun. That is, the user(s) 102 that is/are currently winning the multi-player mini game (e.g., highest amount of points/currency) when the predetermined amount of time expires may be declared the winner(s). In response to the winner(s) of the multi-player mini game being determined, the winner(s) may be displayed within the virtual environment to the participating users 102.

Block 212 illustrates awarding a benefit to at least the winner of the multi-player mini game. More particularly, in response to determining one or more winners of the multi-player mini game, a particular benefit, such as a prize, an award, an amount of points or currency (e.g., dollars, coins, chips, etc.), etc., may be awarded to that user 102 (or multiple users 102). Similar benefits may also be awarded to other users 102 that participated in the multi-player mini game (e.g., a second place user 102, a third place user 102, etc.). Moreover, benefits may be awarded to each user 102 that participated in the multi-player mini game, where the amount of benefits that are awarded may depend upon the performance of each user 102. Regardless of which users 102 receive benefits, such benefits may be added to a cumulative point or currency total that is associated with the game 116 that was being played prior to the multi-player mini game being triggered.

Block 214 illustrates resuming play of the game for the multiple users. More particularly, once the multi-player mini game is concluded, each of the participating users 102 may resume the game 116 that was previously being played. A portion of the virtual environment, a different environment, or a separate window, page, or screen that displayed the multi-player mini game may remain or may be removed.

Therefore, a single player game 116 being independently played by multiple users 102 within a virtual environment may be transitioned to a multi-player collaborative and/or competitive mini game. The multi-player mini game may be triggered in response to certain criteria associated with the game 116 being satisfied and the progression or performance of the participating users 102 may be displayed in real-time during play of the multi-player mini game. Upon conclusion of the multi-player mini game, the participating users 102 may resume play of the single player game.

### Single Player Game

FIG. 3 illustrates an example user interface that illustrates multiple users playing a game in a virtual environment 300. More particularly, multiple users 102(1)-102(4) (collectively referred to as “users 102”) may each be situated around, or in close proximity to, a virtual table 302 within the virtual environment 300, where each of the users 102 may be playing a single player game 304. As illustrated in FIG. 3, the game 304 being played by each of the users 102 may be a virtual slot machine game 304. However, the users 102 may be playing any type of single player game 304. For the purposes of this discussion, a virtual slot machine may correspond to a game 304 where multiple reels (e.g., three reels) may be spun in response to a user actuation (e.g., pushing a button, making contact with a touch-sensitive display, etc.) from one of the users 102. The users 102 may place a bet (e.g., points, currency, coins, chips, etc.) and then cause the one or more reels to spin. Each of the reels may include symbols or images that correspond to symbols and images on the other reels. When the reels are spun and then stop spinning, the symbols images on the reels may be visible to the users 102. The virtual slot game 304 may pay out points, currency, coins, chips, etc., based at least in part on the multiple reels having matching symbols/images or specific patterns or combinations of symbols/images.

As shown, each of the users 102 may be operating their own virtual slot machine at the virtual table 302. In various embodiments, the users 102 may be playing the slot machine game 304 independently from the other users 102, thus making the slot machine games 304 single player games 304. In response to the users 102 betting currency (e.g., points, coins, chips, etc.) and playing the game 304 (e.g., spinning the reels), the users 102 may win one or more jackpots if the reels display predetermined patterns or combinations of symbols/images. Alternatively, if such patterns or combinations do not appear after the reels stop spinning, the users 102 may bet additional currency to further play the game 304. As a result, since the users 102 may bet currency to play, and possibly be awarded currency upon hitting a particular combination of symbols/images on the reels, an amount of currency associated with each user 102 may fluctuate upwards or downwards during play of the game 304.

Since each of the multiple users 102 are situated around a virtual table 302 within the virtual environment 300, the game 304 may have a social or interactive component. For instance, the users 102 may communicate (e.g., chat, send messages, etc.) with one another while the users 102 are playing the game 304. Moreover, the users 102 may determine various information about the other users 102 that are playing the game 304 within the virtual environment 300. For instance, the virtual environment 300 may display user information 306 for each of the users 102. In some embodiments, the user information 306 may correspond to any information that identifies the users 102. Such information may include text (e.g., a name, username, etc.), symbols, images, or an avatar that represents the users 102 or that is otherwise selected by the users 102. This identifying user information 306 may allow a particular user 102 to determine who else is playing the game 304, which may include users 102 that the user 102 is familiar with or has previously played with.

In additional embodiments, the virtual environment 300 may display game data 308 for each of the users 102. The game data 308 may represent a user's 102 progression through the game 304 and/or a user's 102 performance or status with respect to the game 304. For instance, the game data 308 may indicate a duration the user 102 has played the game 304 and/or an extent to which the user 102 has progressed through the game 304. Moreover, the game data 308 may represent a currency (e.g., points, chips, coins, etc.) associated with the user 102, such as an amount of currency won for a particular spin of the reels, an amount bet for a particular spin of the reels, and/or a cumulative amount of currency earned or won by the user 102.

During play of the game 304, at least one of the users 102 may cause a criteria 310 to be met or satisfied, which may then cause the criteria 310 to be displayed within the virtual environment 300. Such criteria 310 may correspond to a predetermined event that may occur during play of the game 304. For instance, the criteria 310 may relate to one of the users 102 reaching a certain amount of points or currency. Here, the criteria 310 may correspond to one of the users 102 hitting a particular combination of symbols/images that are displayed on the reels, which may be displayed in response to the user 102 spinning the reels. For instance, the criteria 310 may be satisfied when one of the users 102 (e.g., user 102(1)) hits the same symbol/image on each one of the multiple reels. In addition to the criteria 310 being satisfied, the user 102 that caused the criteria 310 to be met may receive an award of points, currency, etc. (e.g., a jackpot).

### Triggering a Multi-Player Mini Game

FIG. 4 illustrates an example user interface that illustrates causing a multi-player mini game to be triggered within a virtual environment 400. As shown in FIG. 3, a particular criteria 310 may be satisfied by at least one user 102 causing an event associated with the game 304 to occur. In response to the criteria 310 being satisfied, a multi-player mini game 402 may be triggered. As discussed above, the multi-player mini game 402 may correspond to a collaborative and/or competitive multi-player game in which some or all of the users 102 within the virtual environment 400 may participate. In the context of a virtual slot machine game 304, the multi-player mini game 402 may be triggered in response to one of the users 102 hitting a particular combination of symbols/images that are displayed on the reels. Moreover, the user 102 that actually caused the multi-player mini game 402 to be triggered may be revealed to the other users 102.

During the multi-player mini game 402, some or all of the participating users 102 may attempt to reach a particular goal, such as attaining a particular monetary or point total. The multi-player mini game 402 may be collaborative in the sense that some or all of the participating users 102 may be working together to achieve this goal. Alternatively, or in addition, the multi-player mini game 402 may be competitive in the sense that some or all of the participating users 102 may be competing against the other users 102 in order to reach that goal. In either scenario, the multi-player mini game 402 may display the progression or performance of some or all of the users 102 in real-time, thus allowing the users 102 to determine how they are performing with respect to the other users 102.

In some embodiments, the particular multi-player mini game 402 that is to be presented and subsequently played may be based on the symbols/images on the reels that are associated with the criteria 310. For instance, if three “race” images (e.g., car images, a checkered flag, etc.), the multi-player mini game 402 may relate to a race around a track. In other embodiments, the particular multi-player mini games 402 that are to presented may be randomized or may be selected based on a predefined order. Moreover, when the multi-player mini game 402 is triggered and presented to the users 102, the users 102 may not be allowed to further spin the reels, and the state of the virtual table 302 may change to reflect the type of multi-player mini game 402 that is to be played. In other embodiments, a pop-up window that presents the multi-player mini game 402 may appear. In either instance, the symbols/images on the reels may be updated to reflect the theme of the selected multi-player mini game 402. For instance, for a race-themed multi-player mini game 402, the symbols/images on the reels may be racing themed, which may include images of race cars, race car drivers, a race car track, a checkered flag, and so on.

In some embodiments, the reels of the virtual slot machine game 304 may be upgraded while the games 304 and/or the multi-player mini game 402 are being played. In some embodiments, the upgrading of the reels may reflect the progression of players with respect to the virtual slot machine games 304 and/or the multi-player mini game 402. For example, the reels for a particular player may be enhanced as the player progresses through the virtual slot machine games 304 and/or the multi-player mini game 402, or the current state of the reels may represent a player's progression through the virtual slot machine games 304 and/or the multi-player mini game 402. In other embodiments, upgrading the reels may influence the probability or the outcome of the virtual slot machine games 304 and/or the multi-player mini game 402. For instance, a player with upgraded or enhanced reels may have a higher probability of winning the virtual slot machine games 304 and/or the multi-player mini game 402, whereas a player with reels having fewer upgrades or enhancements may have a lesser chance of winning the virtual slot machine games 304 and/or the multi-player mini game 402.

Upon the multi-player mini game 402 being triggered, the users 102 may cause the reels of the virtual slot machine games 304 to spin in order to win the most currency (e.g., money, points, chips, etc.). Since the winner of the multi-player mini game 402 may be based on the user 102 that wins the most amount of currency, the users 102 may be incentivized to place higher bets and/or to spin the reels more rapidly.

As shown in FIG. 4, the multi-player mini game 402 may be represented by a track that includes a start 404 and a finish 406. Although a track is shown, any type of game or theme may be used to illustrate the user's 102 progression and/or performance with respect to the multi-player mini game 402. In some embodiments, each of the users 102 may begin at the start 404 and then progress towards the finish 406 during play of the multi-player mini game 402. For instance, each of users 102(1), 102(2), 102(3), and 102(4) are shown to be in different locations on the track, with user 102(4) appearing to be in first place and either at or near the finish 406. In addition to displaying the relative progression of the users 102, the multi-player mini game 402 may also show the amount of currency won during the multi-player mini game 402. Therefore, each of the users 102 may determine how they are performing with respect to the other users 102 that are participating in the multi-player mini game 402. Although not show, each user 102 may be uniquely represented by text, a symbol, an image, an avatar, a color, etc., such that the users 102 may determine the relative position of each of the other users 102.

When one of the users 102 reaches the finish 406, or when a predetermined duration of time associated with the multi-player mini game 402 has expired, a winner 408 of the multi-player mini game 402 may be declared. Here, since user 102(4) appears to have reached the finish 406, the virtual environment 400 may show that that user 102(4) has won the multi-player mini game 402. In certain embodiments, the winner 408 of the multi-player mini game 402 may be presented with a graphic, possibly within a pop-up window, that displays a “victory” screen. On the other hand, users 102 that did not win the multi-player mini game 402 may be presented with a “lose” screen, which may illustrate how close those users 102 were to winning the multi-player mini game 402.

In response, the winner 408 of the multi-player mini game 402, and possibly other users 102 that participated, may receive some benefit, which may include an amount of points, an amount of currency, an upgrade of game features, and so on. In some embodiments, the points/currency that are received by the users 102 may be based on the number of reels spun or the amount of currency won during the multi-player mini game 402.

Subsequently, the users 102 that participated in the multi-player mini game 402, which, in some circumstances, may be all of the users 102 that were playing the game 304 when the multi-player mini game 402 was triggered, may resume the game 304 that was previously being played by those users 102. The portion of the virtual environment 400 that includes the multi-player mini game 402 may remain in the event an additional criteria 310 is satisfied, which may then trigger an additional multi-player mini game 402. Alternatively, this portion may be removed or may disappear when the multi-player mini game 402 concludes and/or when the users 102 resume paying the game 304.

Accordingly, in the context of a single player virtual slot machine game 304 where multiple users 102 are situated at a virtual table 302 within a virtual environment 400, each of the users 102 may play the slot machine game 304 independently from the other users 102. However, in response to a certain criteria 310 being satisfied, a multi-player collaborative and/or competitive game 402 may be triggered, which may cause all or some of the multiple users 102 to play the multi-player mini game 402. The progression and/or performance of the users 102 with respect to the game 304 and the multi-player mini game 402 may be dynamically displayed in real-time. Therefore, the systems and/or processes described herein may allow users 102 to play a single player game 304, while also having the opportunity to participate in a multi-player game 402 that is associated within the single player game 304, which may lead to a more exciting and positive gaming experience.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
determining that multiple users are playing a game;
determining that a criteria associated with the game has been satisfied;
presenting a multi-player mini game to two or more of the multiple users based at least in part on the criteria being satisfied;
dynamically displaying a progress or a performance of each of the two or more of the multiple users during progression of the multi-player mini game; and
in response to determining one or more winners of the multi-player mini game, allowing the two or more of the multiple users to resume play of the game.

2. The method as recited in claim 1, wherein the game is played independently by each of the multiple users such that an outcome of the game for each of the multiple users is unaffected by game play by other of the multiple players of the game.

3. The method as recited in claim 1, wherein the game is played within a virtual environment, the virtual environment including a virtual table in which each of the multiple users is positioned around and where each of the multiple users is uniquely represented within the virtual environment.

4. The method as recited in claim 1, wherein the criteria corresponds to one or more events associated with the game that occur based at least in part on an action taken by at least one of the multiple users.

5. The method as recited in claim 1, wherein the multi-player mini game is a collaborative multi-player mini game where the two or more of the multiple users are to achieve a common goal.

6. The method as recited in claim 1, wherein the multi-player mini game is a competitive multi-player mini game where each of the two or more of the multiple users competes against one another during the multi-player mini game.

7. The method as recited in claim 1, wherein:
the game is a virtual slot machine game that includes multiple reels; and
the criteria corresponds to at least one of the multiple users hitting a predetermined combination of the multiple reels.

8. The method as recited in claim 1, further comprising providing an award to the one or more winners of the multi-player mini game, the reward being added to a cumulative award total that is associated with the one or more winners of the multi-player mini game.

9. The method as recited in claim 1, wherein the progress or performance of each of the multiple users is dynamically displayed by uniquely identifying each of the multiple users in a manner that is perceivable by the multiple users.

10. One or more computer-readable media having computer-executable instructions that, when executed by one or more processors, perform operations comprising:
determining that multiple users are independently playing a game associated with a network;
identifying one or more criteria associated with the game;
in response to a user action by at least one of the multiple users, determining that at least one of the one or more criteria has been satisfied; and
triggering a presentation of a multi-player mini game to the multiple users based at least in part on the at least one criteria being satisfied.

11. The one or more computer-readable media as recited in claim 10, wherein the operations further comprise:
automatically causing each of the multiple players to participate in the multi-player mini game;
displaying a progress or a performance of each of the multiple users in real-time during a progression of the multi-player mini game;
determining one or more winners of the multi-player mini game; and
providing an award to the one or more winners of the multi-player mini game, the award being added to a cumulative award total associated with the one or more winners of the multi-player mini game.

12. The one or more computer-readable media as recited in claim 10, wherein:
the game is a single player game that is played independently by each of the multiple users; and
the multi-player mini game is a collaborative multi-player game or a competitive multi-player game that is associated with the game.

13. The one or more computer-readable media as recited in claim 12, wherein the multi-player mini game is presented in a physical environment, within a virtual environment in which the game is being played, within a virtual environment different from the virtual environment in which the game is being played, in a pop-up window, in a separate page or screen, or overlaid on the game.

14. The one or more computer-readable media as recited in claim 10, wherein the one or more criteria correspond to one or more events that occur within the game in response to an action taken by at least one of the multiple users.

15. The one or more computer-readable media as recited in claim 10, wherein:
the game is a virtual slot machine game;
each of the multiple users are playing the virtual slot machine game within a virtual environment; and
the multi-player mini game is presented within the virtual environment in response to determining that the at least one criteria has been satisfied.

16. A system comprising:
memory;
one or more processors; and
a graphical user interface, executable by the one or more processors and associated with the memory, that includes:
a first portion that enables multiple users to play a single player game within a virtual environment, the single player game being associated with one or more criteria; and
a second portion that presents a multi-player mini game in response to at least one of the one or more criteria being satisfied, the at least one criteria being satisfied based at least in part on a user action taken by at least one of the multiple users with respect to the single player game.

17. The system as recited in claim 16, wherein:
two or more of the multiple users play the multi-player mini game in collaboration with one another or in competition with one another;
a progression or a performance of the two or more of the multiple users is displayed during a progression of the multi-player mini game; and
at least one of the two or more of the multiple users is declared a winner of the multi-user mini game based at least in part on the progression or the performance of the two or more of the multiple users.

18. The system as recited in claim 16, wherein the second portion is included within the virtual environment, included within a virtual environment that is different from the virtual environment, adjacent to the first portion, included within a pop-up window, included within a separate page or screen, or overlaid on the first portion.

19. The system as recited in claim 16, wherein:
at least one of the multiple users is declared a winner of the multi-player mini game; and
in response to the winner being declared, the multiple users are directed to the first portion to resume play of the single player game.

20. The system as recited in claim 16, wherein the one or more criteria correspond to one or more events that occur within the single player game.
